(19) United States
(12) Patent Application Publication
(10) Pub. No.: US 2021/0108063 A1
(43) Pub. Date: Apr. 15, 2021

(54) ETHYLENE-TETRAFLUOROETHYLENE COPOLYMER DISPERSIONS AND COATED ARTICLES THEREOF

(71) Applicant: 3M INNOVATIVE PROPERTIES COMPANY, St Paul, MN (US)

(72) Inventors: Michael C. Dadalas, Burghausen (DE); Klaus Hintzer, Kastl (DE); Per M. Nelson, Woodbury, MN (US)

(21) Appl. No.: 16/464,325

(22) PCT Filed: Nov. 21, 2017
(86) PCT No.: PCT/US17/62663

§ 371 Date: May 28, 2019

Related U.S. Application Data
(60) Provisional application No. 62/428,600, filed on Dec. 1, 2016.

(51) Int. Cl. C08L 27/18; C08L 23/08; C08L 27/20; C08L 27/16; C08K 5/06; C08K 5/09; C08K 5/42; D06M 15/256; D06M 15/227

(52) U.S. Cl. CPC C08L 27/18; C08L 23/08; C08L 27/20; C08L 27/16; C08K 5/06; C08K 2201/019; C08K 5/42; D06M 15/256; D06M 15/227; C08L 2201/50; C08K 5/09

(57) ABSTRACT

Described herein is an aqueous polymer dispersion comprising: (a) an ethylene-tetrafluoroethylene copolymer (b) 1-25 wt % of a non-ionic, branched, alkoxy alcohol surfactant versus the ethylene-tetrafluoroethylene copolymer, and (c) 0.05-5 wt % non-fluorinated anionic surfactant versus the ethylene-tetrafluoroethylene copolymer. Such aqueous polymer dispersion may be used to coat a fiber-containing substrate.

### TECHNICAL FIELD

Aqueous dispersions of ethylene-tetrafluoroethylene copolymer are disclosed along with methods of coating such dispersions, and articles thereof.

### SUMMARY

There is a desire for alternative ETFE copolymer dispersion that can be used as coatings. These dispersions can provide improvements, such as larger coating thickness, stiffness of the resulting article, improved shear stability, and/or improved chemical resistance of the article.

In one aspect, an aqueous polymer dispersion is provided comprising: (a) an ethylene-tetrafluoroethylene copolymer; (b) 1-25 wt % of a non-ionic, branched, alkoxy alcohol surfactant versus the ethylene-tetrafluoroethylene copolymer; and (c) 0.05-5 wt % non-fluorinated anionic surfactant versus the ethylene-tetrafluoroethylene copolymer.

In another aspect, a method of coating a fiber-containing substrate is provided, the method comprising, coating the fiber-containing substrate with an aqueous polymer dispersion containing: (a) an ethylene-tetrafluoroethylene copolymer; (b) 1-25 wt % of a non-ionic, branched, alkoxy alcohol surfactant versus the ethylene-tetrafluoroethylene copolymer; and (c) 0.05-5 wt % non-fluorinated anionic surfactant versus the ethylene-tetrafluoroethylene copolymer; wherein the fiber-containing substrate includes fiber capable of withstanding the annealing temperature of the ethylene-tetrafluoroethylene copolymer.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“backbone” refers to the main continuous chain of the polymer;

“interpolymerized” refers to monomers that are polymerized together to form a polymer backbone;

“monomer” is a molecule which can undergo polymerization which then form part of the essential structure of a polymer;

“perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, chlorine atoms, bromine atoms and iodine atoms; and

“polymer” refers to a macrostructure having a number average molecular weight (Mn) of at least 50,000 dalton, at least 100,000 dalton, at least 300,000 dalton, at least 500,000 dalton, at least, 750,000 dalton, at least 1,000,000 dalton, or even at least 1,500,000 dalton and not such a high molecular weight as to cause premature gelling of the polymer.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

Fluoropolymer coatings for fabrics are used to increase strength, weatherability, stiffness, and resistance to flex wear of the fabric. The fluoropolymer coatings typically comprise polytetrafluoroethylene (PTFE), copolymers of hexafluoropropylene and tetrafluoroethylene (FEP), and copolymers of tetrafluoroethylene and perfluoroalkoxy vinyl ether (PFA).

In the present disclosure, it has been discovered that ethylene-tertrafluoroethylene copolymer dispersions for coatings can be produced, which in addition to being substantially free of a fluorinated emulsifier, can provide improved shear stability, improved chemical resistance, a large coating thickness, and/or adjust the stiffness of the resulting substrate.

Aqueous Dispersion

The aqueous fluoropolymer dispersions of the present disclosure comprise an ethylene-tetrafluoroethylene copolymer. As used herein, an ethylene-tetrafluoroethylene copolymer, means a crystalline thermoplastic polymer (i.e., a fluoroplastic) which is a copolymer of ethylene, tetrafluoroethylene and optionally additional monomer. Ethylene-tetrafluoroethylene copolymer is also known in the art as ETFE or poly(ethylene-tetrafluoroethylene), and herein the acronym ETFE may be used synonymously for convenience. The mole ratio of ethylene to tetrafluoroethylene can be about 35-60 to 65-40. An additional monomer can be present in an amount such that the mole ratio of ethylene to tetrafluoroethylene to additional monomer is about 40-60:15-50:0-40. The additional monomer can be, for example hexafluoropropylene; vinylidene fluoride, another comonomer, and combinations thereof.

In one embodiment, the ETFE is derived from (i) at least 45, 50, 55, or even 60 wt % tetrafluoroethylene; and at most 90, 85, 80, or even 70 wt % tetrafluoroethylene; and (ii) at least 5, 10, or even 15 wt % ethylene; and at most 40, 35, or even 30 wt % ethylene. The optional additional monomer may be (iii) 0 or at least 0.5, 1, 1.5, or even 2 wt % hexafluoropropylene; and at most 30, 25, 20, or even 10 wt % hexafluoropropylene; (iv) 0 or at least 0.5, 1, 1.5, or even 2 wt % vinylidene fluoride; and at most 30, 25, 20, 15, or even wt % vinylidene fluoride; and/or (v) at least 0.5, 1, 1.5, or even 2 wt % other comonomers; and at most 10, 7, or even 5 wt % other comonomers. Such other comonomers include: trifluorochloroethylene (CTFE), 3,3,3-trifluoropropylene-1; 2-trifluoromethyl-3,3,3-trifluoropropylene-1; or fluoro ether monomers of Formulas (I) or (II), where Formula (I) is

CF₂═CF(CF₂)_{b}O(R_{f′}O)ₙ(R_{f′}O)ₘR_{f} (I)

where R_{f′} and R_{f′} are independently linear or branched fluoroalkylene groups comprising 2, 3, 4, 5, or 6 carbon atoms, b is 0 or 1, m and n are independently an integer selected from 0, 1, 2, 3, 4, 5, 6, 7, 8, 9, and 10, and R_{f} is a fluoroalkyl group comprising 1, 2, 3, 4, 5, or 6 carbon atoms. Exemplary perfluorinated vinyl ether monomers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, perfluoro-methoxy-methylvinylether (CF₃—O—CF₂—O—CF═CF₂), and CF₃—(CF₂)₂—O—CF(CF₃)—CF₂—O—CF(CF₃)—CF₂—O—CF═CF₂, perfluoro (methyl allyl) ether (CF₂═CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂, CF₂═CFOCF₂OCF₂CF₃, CF₂═CFOCF₂OC₃F₇, and combinations thereof. Formula (II) are partially fluorinated ether monomers of the formula:

CXX═CX(CYY)_{b}O(R_{f′}O)ₙ(R_{f′}O)ₘR_{f} (II)

where X is independently selected from H or F; Y is H, F, CF₃; R_{f′} and R_{f′} are independently linear or branched fluoroalkylene radical groups comprising 2, 3, 4, 5, or 6 carbon atoms, b is 0 or 1, m and n are independently an integer selected from 0, 1, 2, 3, 4, 5, 6, 7, 8, 9, and 10, and R_{f} is a fluoroalkyl group comprising 1, 2, 3, 4, 5, or 6 carbon atoms. Exemplary partially fluorinated ether monomers include for example: CF₃—O—CH═CF₂, CF₃—O—CF═CFH, CF₃—O—CH═CH₂, CF₃—O—CF₂—CF═CH₂, CF₃—O—CF₂—CH═CH₂, CF₃—CH₂—O—CF₂—CF═CF₂, HCF₂—CH₂—O—CF₂—CF═CF₂, HCF₂—CF₂—CF₂—O—CF═CF₂, HCF₂—CF₂—CF₂—O—CF—CF═CF₂, CF₃—CFH—CF₂—O—CF═CF₂, and combinations thereof.

The melting point of ETFE varies depending on the mole ratio of ethylene and tetrafluoroethylene and the presence or not of additional monomer. In one embodiment, the ETFE has a melting point of at least 120, 140, 180, 200, 220, or even 230° C.; and at most 285, 280, 275, or even 270° C.

In one embodiment, the ETFE has a crystallinity of at least 200, 300, 40% or even 50%.

In one embodiment, the ETFE has a melt flow index (MFI) taken at 297° C. with 5 kg of at least 1, 5, 10, or even 15 g/10 min; and at most 100, 80, 70, 60, 40, 25 or even 20 g/10 min.

ETFE is commercially available from a number of suppliers, including from 3M Co. under the trade designation “3M DYNEON FLUOROTHERMOPLASTICS ET X 6425”; Chemours under the trade designation “TEFZEL” (e.g., grades ETFE 200, ETFE 280, and ETFE HT-2181); and from Daikin Industries under the trade designation “NEOFLON” (e.g., grades EP-541, EP-610 and EP-620).

The average particle size (average particle diameter) of ETFE in the aqueous polymer dispersion is generally in the range of 10 nm to 400 nm, preferably between 25 nm and 300 nm. The average particle diameter is generally determined through dynamic light scattering and a number average particle diameter may thereby be determined. The particle size distribution may be mono-modal as well as multi-modal such as bimodal.

The aqueous polymer dispersion of the present disclosure further comprises a non-ionic surfactant. The non-ionic surfactant is non-fluorinated and branched comprising an alcohol moiety and at least one ether moiety.

In one embodiment, the non-ionic, branched, alkoxy alcohol surfactant comprises at least two —CH(CH₃)₂ groups.

In one embodiment, the non-ionic, branched, alkoxy alcohol surfactant is of the formula (III)

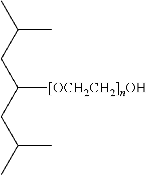

where n is an integer of 6, 7, 8, 9, 10, 11, or 12. Such surfactants are available under the trade designation “TERGITOL TMN-6” “TERGITOL TMN-10” and “TERGITOL TMN-100” available from Dow Chemical Co., Midland, Mich.

The non-ionic, branched, alkoxy alcohol surfactant is generally present in the aqueous polymer dispersion in an amount of at least 1, 5, 10, 12, 13, or even 15 wt %; and at most 18, 20, or even 25% by weight relative to the total weight of ETFE in the dispersion. If too much non-ionic, branched, alkoxy alcohol surfactant is present, the aqueous polymer dispersion can become too viscous. If too little non-ionic, branched, alkoxy alcohol surfactant is present, stability of the aqueous polymer dispersion can be compromised.

The aqueous polymer dispersion of the present disclosure further comprises a non-fluorinated anionic surfactant. This non-fluorinated anionic surfactant can be used to adjust the viscosity of the aqueous dispersion and/or increase the stability the dispersion.

In one embodiment, the anionic non-fluorinated surfactants are surfactants that have an acid group that has a pKₐ of not more than 4, preferably not more than 3. Examples of non-fluorinated anionic surfactants include surfactants that have one or more anionic groups. Anionic non-fluorinated surfactants may include, in addition to one or more anionic groups, other hydrophilic groups such as polyoxyalkylene groups having 2 to 4 carbons in the oxyalkylene group, such as polyoxyethylene groups, or groups such as such as amino groups. Nevertheless, when amino groups are contained in the surfactant, the pH of the dispersion should be such that the amino groups are not in their protonated form. Typical non-fluorinated anionic surfactants include anionic hydrocarbon surfactants. The term “anionic hydrocarbon surfactants” as used herein comprises surfactants that comprise one or more hydrocarbon moieties in the molecule and one or more anionic groups, in particular acid groups such as sulphonic, sulfuric, phosphoric and carboxylic acid groups and salts thereof. Examples of hydrocarbon moieties of the anionic hydrocarbon surfactants include saturated and unsaturated aliphatic groups having for example 6 to 40 carbon atoms, preferably 8 to 20 carbon atoms. Such aliphatic groups may be linear or branched and may contain cyclic structures. The hydrocarbon moiety may also be aromatic or contain aromatic groups. Additionally, the hydrocarbon moiety may contain one or more hetero atoms such as for example oxygen, nitrogen and sulfur.

Particular examples of anionic hydrocarbon surfactants for use in this disclosure include alkyl sulfonates such as lauryl sulfonate, alkyl sulfates such as lauryl sulfate, alkylarylsulfonates and alkylarylsulfates, fatty (carboxylic) acids and salts thereof such as lauric acids and salts thereof and phosphoric acid alkyl or alkylaryl esters and salts thereof. Commercially available anionic hydrocarbon surfactants that can be used include those available under the trade designations “EMULSOGEN LS” (sodium lauryl sulfate) and “EMULSOGEN EPA 1954” (mixture of C₁₂ to C₁₄ sodium alkyl sulfates) available from Clariant GmbH and “TRITON X-200” (sodium alkylsulfonate) available from Union Carbide. Preferred are anionic hydrocarbon surfactants having a sulfonate group.

Other suitable anionic non-fluorinated surfactants include silicone based surfactants such as polydialkylsiloxanes having pendent anionic groups such as phosphoric acid groups, carboxylic acid groups, sulfonic acid groups and sulfuric acid groups and salts thereof.

The amount of non-fluorinated, anionic surfactant added to the dispersion will generally depend on the amount of ETFE, nature and amount of non-ionic surfactant present in the dispersion, and nature and amount of fluorinated surfactant that may be present in the dispersion. The non-fluorinated, anionic surfactant present in the aqueous polymer dispersion is generally in an amount of at least 0.05, 0.1, 0.3, or even 0.5 wt %; and at most 1, 3, or even 5 wt % relative to the total weight of ETFE in the ETFE copolymer dispersion. If too much non-fluorinated, anionic surfactant is present, the aqueous polymer dispersion can become too viscous. If too little non-fluorinated, anionic surfactant is present, stability of the aqueous polymer dispersion can be compromised.

If used for coating purposes, fluoropolymer dispersions typically are in a more concentrated form than the as-polymerized dispersion (or raw dispersion). For example, as polymerized dispersions comprise a polymer solid content of typically 10 to 30 wt % solids, while dispersions used for coatings comprise at least 40 or even 50 wt % solids.

The aqueous polymer dispersions of the present disclosure can be generally obtained by starting from a so-called raw dispersion, which may result from an emulsion polymerization of fluorinated monomers using techniques known in the art.

In one embodiment, the ETFE polymerization is conducted in the absence of fluorinated emulsifiers. Surfactants and emulsifiers are compounds which comprise a hydrophobic tail and a hydrophilic head. As used herein, an emulsifier refers to a compound that is used to stabilize a mixture during polymerization, whereas a surfactant refers to a compound that is added after polymerization. In one embodiment, the surfactants disclosed herein may be present during the polymerization. Alternatively, the surfactants disclosed herein are added after the polymerization.

Non-ionic, non-fluorinated saturated emulsifiers may be used to carry out the polymerization including polycaprolactones (for example as disclosed in WO2009/126504), siloxanes (for example as disclosed in EP 1 462 461), polyethylene/polypropylene glycols (for example as disclosed in WO2008/073686, U.S. Pat. No. 8,158,734 or EP 2 089 462), cyclodextrines (for example as described in EP 0 890 592), carbosilanes (for example as described in EP 2 069 407) and sugar-based emulsifiers such as glycosides. Other examples include polyether alcohols, sugar-based emuslifiers or hydrocarbon based emulsifiers. The long chain unit may contain from 4 to 40 carbon atoms. Typically, the emulsifier is based on a hydrocarbon chain. The emulsifier typically contains or consists of hydrocarbon or a (poly)oxy hydrocarbon chain, i.e. a hydrocarbon chain that is interrupted once or more than once by an oxygen atom. Typically, the long chain unit is an alkyl chain or a (poly)oxy alkyl chain, i.e. an alkyl chain that is interrupted once or more than once by an oxygen atom to provide a catenary ether function. The long chain unit may be linear, branched or cyclic but preferably is acyclic and contains one or more polar functional non-ionic group. See WO 2016/137851 (Jochum et al.), herein incorporated by reference.

Other suitable non-fluorinated emulsifiers include saturated anionic emulsifiers such as polyvinylphosphinic acids, polyacrylic acids and polyvinyl sulfonic acids alkyl phosphonic acids (for example, alkyl phosphates, hydrocarbon anionic surfactants as described, for example in EP 2091978 (Tang) and EP 1325036 (Tang), herein incorporated by reference).

Particular embodiments of anionic emulsifiers include sulfate or sulfonate emulsifiers, typically hydrocarbon sulfates or sulfonates wherein the hydrocarbon part may be substituted by one or more catenary oxygen atoms, e.g. the hydrocarbon part may be an ether or polyether residue. The hydrocarbon part is typically aliphatic. The hydrocarbon part may contain from 8 to 26, preferably from 10 to 16 or from 10 to 14 carbon atoms. In a preferred embodiment, the non-fluorinated emulsifiers are sulfonates, for example monosulfonates or polysulfonates, e.g. disulfonates, preferably secondary sulfonates.

Other examples of oxygen containing moieties include carboxylate ester (—C(═O)—) groups and carboxamide (—NYX—C(═O)— groups wherein Y and X may be H, or an alkyl group, preferably a methyl or ethyl group and combinations thereof.

Examples of commercially available sulosuccinate, sulfonate or sulfate emulsifiers with one or more oxygen containing moieties include, but are not limited to those available under the trade designation “GENAPOL LRO” (alkyl ether sulfate); “EMULSOGEN SF”; “AEROSOL OT 75” (dialkyl sulfosuccinates); “HOSTAPON SCI 65 C” (alkyl fatty acid isethionate) sulfonate), and “HOSTAPON CT” from Clariant.

If such above-referenced non-fluorinated emulsifiers are used, they may not be removed from the dispersion.

In one embodiment, the ETFE is polymerized in the presence of a fluorinated emulsifier such as those known in the art. Fluorinated emulsifiers include compounds that correspond to the general formula:

Y—R_{f}—Z-M

wherein Y represents hydrogen, Cl or F; R_{f} represents a linear, cyclic or branched perfluorinated or partially fluorinated alkylene having 4 to 18 carbon atoms and which may or may not be interrupted by one or more ether oxygens, Z represents an acid anion (e.g. COO⁻ or SO₃⁻) and M represents a cation like an alkali metal ion, an ammonium ion or H*. Exemplary emulsifiers include: perfluorinated alkanoic acids, such as perfluorooctanoic acid and perfluorooctane sulphonic acid. Preferably, the molecular weight of the emulsifier is less than 1,000 g/mole.

Specific examples are described in, for example, U.S. Pat. Publ. 2007/0015937 (Hintzer et al.). Exemplary emulsifiers include: CF₃CF₂OCF₂CF₂OCF₂COOH, CHF₂(CF₂)₅COOH, CF₃(CF₂)₆COOH, CF₃O(CF₂)₃₀CF(CF₃)COOH, CF₃CF₂CH₂OCF₂CH₂OCF₂COOH, CF₃O(CF₂)₃OCHFCF₂COOH, CF₃O(CF₂)₃OCF₂COOH, CF₃(CF₂)₃(CH₂CF₂)₂CF₂CF₂CF₂COOH, CF₃(CF₂)₂CH₂(CF₂)₂COOH, CF₃(CF₂)₂COOH, CF₃(CF₂)₂(OCF(CF₃)CF₂)OCF(CF₃)COOH, CF₃(CF₂)₂(OCF₂CF₂)₄₀CF(CF₃)COOH, CF₃CF₂O(CF₂CF₂)₃CF₂COOH, and their salts.

Other emulsifiers include fluorinated emulsifiers that are not carboxylic acids, such as for example, sulfinates or perfluoroaliphatic sulfinates or sulfonates. The sulfinate may have a formula Rf—SO₂M, where Rf is a perfluoroalkyl group or a perfluoroalkoxy group. The sulfinate may also have the formula Rf′— (SO₂M)n where Rf′ is a polyvalent, preferably divalent, perfluoro radical and n is an integer from 2-4, preferably 2. Preferably the perfluoro radical is a perfluoroalkylene radical. Generally, Rf and Rf′ have 1 to 20 carbon atoms, preferably 4 to 10 carbon atoms. M is a cation having a valence of 1 (e.g. H+, Na+, K+, NH₄+, etc.). Specific examples of such fluorinated emulsifiers include, but are not limited to C₄F₉—SO₂Na; C₆F₁₃—SO₂Na; C₈F₁₇—SO₂Na; C₆F₁₂—(SO₂Na)₂; and C₃F₇—O—CF₂CF₂—SO₂Na.

In one embodiment, the molecular weight of the anionic part of the fluorinated emulsifier, is less than 1500, 1000, or even 500 grams/mole.

Fluorinated emulsifiers are often desirable in fluoropolymer polymerizations as opposed to non-fluorinated emulsifiers due to the improved product yield and/or shortened run times. However, because fluorinated emulsifiers have raised environmental concerns, measures have been taken to either completely eliminate the fluorinated surfactants from aqueous dispersion or at least to minimize the amount thereof in an aqueous dispersion. This is accomplished by either not using a fluorinated emulsifier (as described above) or, after polymerization of the fluoropolymer, removing the fluorinated emulsifier, which will be discussed below.

The raw dispersion is further processed to concentrate the ETFE and, optionally, to remove unwanted substances.

In one embodiment, the raw ETFE dispersion can be contacted with a cation exchange resin to remove cations, which are impurities in starting materials and/or by-products of the polymerization. For example, manganic ions can cause discoloration in the resulting polymer. Therefore, when manganic- or permanganic-based initiators are used, the manganic ions may be removed subsequent to the polymerization by contacting the resulting dispersion with a cation exchange resin such as those available under the trade designation “LEWATIT SP 120” available from Lanxess. Such removal of cations in a fluoropolymer dispersion is known in the art. See, for example, U.S. Pat. No. 5,463,021 (Beyer et al.), herein incorporated by reference

In one embodiment, the raw ETFE dispersion or the ETFE dispersion after removal of cations, can be contacted, after the addition of a non-ionic surfactant into the dispersion, with an anion exchange resin to remove anionic fluorinated compounds such as fluorinated emulsifiers. Such a method is disclosed in detail in U.S. Pat. No. 6,833,403 (Blaedel et al), herein incorporated by reference.

The anion exchange process is preferably carried out in essentially basic conditions. Accordingly, the ion exchange resin will preferably be in the OH— form although anions like fluoride or oxalate corresponding to weak acids may be used as well. The specific basicity of the ion exchange resin is not very critical. Strongly basic resins are preferred because of their higher efficiency in removing the low molecular weight fluorinated emulsifier. The process may be carried out by feeding the ETFE copolymer dispersion through a column that contains the ion exchange resin or alternatively, the ETFE copolymer dispersion may be stirred with the ion exchange resin and the fluoropolymer dispersion may thereafter be isolated by filtration. With this method, the amount of low molecular weight fluorinated emulsifier can be reduced to levels below 150 ppm or even below 10 ppm. Accordingly, ETFE copolymer dispersion substantially free of low molecular weight fluorinated emulsifier may thereby be obtained.

A steam-volatile fluorinated emulsifier in its free acid form may be removed from aqueous ETFE copolymer dispersions, by adding a nonionic surfactant to the aqueous fluoropolymer dispersion and, at a pH-value of the aqueous ETFE copolymer dispersion below 5, removing the steam-volatile fluorinated emulsifier by distillation until the concentration of steam-volatile fluorinated emulsifier in the fluoropolymer dispersion reaches the desired value. Low molecular weight fluorinated emulsifier that can be removed with this process.

As mentioned above, for coating solutions, it is desirable to increase the amount of fluoropolymer solids in the dispersion. To increase the amount of fluoropolymer solids, any of the upconcentration techniques known in the art may be used. These upconcentration techniques are typically carried out in the presence of a non-ionic surfactant, which is added to stabilize the dispersion in the upconcentration process. Suitable methods for upconcentration include ultrafiltration, thermal upconcentration, thermal decantation and electrodecantation as disclosed in U.S. Pat. No. 7,279,522 (Dadalas et al., herein incorporated by reference). In the present disclosure, the non-ionic, branched, alkoxy alcohol surfactant disclosed herein can be used during the upconcentration process to stabilize the dispersion.

The method of ultrafiltration comprises the steps of (a) adding non-ionic surfactant to a dispersion that desirably is to be upconcentrated and (b) circulating the dispersion over a semi-permeable ultra-filtration membrane to separate the dispersion into a fluorinated polymer dispersion concentrate and an aqueous permeate. The circulation is typically at a conveying rate of 2 to 7 meters per second and effected by pumps which keep the fluorinated polymer free from contact with components which cause frictional forces. The method of ultrafiltration further has the advantage that during upconcentration also some low molecular weight fluorinated emulsifier is removed. Accordingly, the method of ultrafiltration may be used to simultaneously reduce the level of low molecular weight fluorinated emulsifier and upconcentrate the dispersion.

To increase the fluoropolymer solids in the aqueous ETFE copolymer dispersion, thermal decantation may also be employed. In this method, a non-ionic surfactant is added to the fluoropolymer dispersion that is desirably upconcentrated and the dispersion is then heated so as to form a supernatant layer that can be decanted and that typically contains water and some non-ionic surfactant while the other layer will contain the concentrated dispersion. This method is for example disclosed in U.S. Pat. No. 3,037,953 (Barnard) and 6153688 (Tashiro et al.).

Thermal upconcentration involves heating of the dispersion and removal of water under a reduced pressure until the desired concentration is obtained.

In accordance with the present invention, the non-fluorinated, anionic surfactant is added prior to or after the upconcentration depending on the method of upconcentration used and is used to control viscosity. For example, if ultrafiltration is used, it will generally be preferred to add the non-fluorinated, anionic surfactant prior to upconcentration. If the thermal upconcentration method is used, the non-fluorinated, anionic surfactant can be added prior to the upconcentration as well as subsequent to the upconcentration.

In one embodiment, the aqueous polymer dispersion of the present disclosure has a surface tension of less than 30 mN/m.

The ETFE copolymer dispersions disclosed herein can be used to coat substrates such as fiber-containing substrates, which may include textiles and fabrics, referred to herein as a fabric. A variety of fiber-containing substrates can be used, so long as the ETFE copolymer dispersion is able to penetrate or “wet” the substrate. The fiber-containing substrate can be a knit, a woven, or non-woven material. Such non-woven materials include melt spun, needle tack, hydroentanglement, blown microfiber, wetlaid, or spunbound materials. Additionally, unidirectional fiber-containing substrates comprising “spread tow” fibers can be used. Woven materials comprising 2- and 3-dimensional weaves also can be used.

In one embodiment, the fiber-containing substrate is made from material able to withstand (e.g., not melt or decompose) high temperatures, such as those used to anneal ETFE. For example, temperatures higher than 300° C., 320° C., or even 350°. Exemplary materials include glass and aramid.

A glass substrate may be prepared from glass styles such as E, D, S, or NE, or mixtures thereof. An aramid substrate may be prepared from aramid materials available under the trade designations “VECTRAN” by Kurrary CO., Ltd., or “KEVLAR”, “NOMEX” and “TECHNORA” by DuPont; and “TWARON” by Teijin Aramid, Arnham, The Netherlands.

In addition to glass and aramid substrates, other high temperature substrates are available. These include fiber-containing substrates made from carbon fiber, oxide fibers, non-oxide fibers. Carbon fibers include PAN and Pitch sourced. Oxide fibers include materials such as silica (SiO₂ for example: Quartz fiber), zirconia, or alumina (such as those available under the trade designation “3M NEXTEL 610 CERAMIC FIBER” from 3M Co., St. Paul, Minn.) and blended oxides such as Alumina-Silicate (such as those available under the trade designation “3M NEXTEL 720 CERAMIC FIBER” from 3M Co.), Aluma-Boro-Silicate (such as those available under the trade designation “3M NEXTEL 312 CERAMIC FIBER” and “3M NEXTEL 440 CERAMIC FIBER” from 3M Co.) and natural mineral oxides including Basalt. Non-oxide fibers include Silicon Carbide.

In one embodiment, the fiber-containing substrate is made from fibers or filaments which have a diameter of at least 4, 5, 6, 9, or even 10 micrometers; and at most 100, 50, 25, or even 20 micrometers.

In one embodiment, the fiber-containing substrate is made from fibers or filaments having a denier of at least 100 and most 6000. In one embodiment, the fiber-containing substrate is made from fibers or filaments having a denier of at least 10000 to at most 30000, 50000, or even higher, depending on the density of the material, filament count and cross sectional area of the filaments. The fibers or filaments may be long relative to their diameters, having aspect ratios greater than 6,000.

In one embodiment, the substrates are derived from low twist or zero twist yarns. In the weaving process, yarn bundles are typically twisted such that they can be readily woven without the bundles losing their integrity. Generally, the warp yarns are pulled or shuttled under tension through a device and the fill yarns are inserted across the rows of warp yarns using a rapier, air jet loom, or shuttle loom, optionally wherein the devices are fitted with a Jaquard machine, for example. Low twist yarns have straighter filaments than can be more readily flattened. The substrates can be prepared by starting with zero or low twist yarns that may or may not be somewhat flat or they can be flattened in a post weaving process where the yarns are mechanically flattened or the yarns can be flattened due to an impinging spray. Examples of such woven glass fabrics include 7628, 1080, or 106 style glasses produced by Hexcel, Seguin, Tex.

In one embodiment, the thickness of the fiber-containing substrate is at least 50, 60, or even 80 micrometers; and at most 500, 300, 200, or even 100 micrometers.

In one embodiment, the fiber-containing substrate has a weight of at least 10, 20, 40 or even 50 g/m² and most 1000, 600, 400, 200 or even 100 g/m².

In some embodiments, a sizing, a binder, or a polymeric treatment may be applied to the substrate prior to coating with the ETFE dispersion in order to enhance adhesion of the ETFE.

In the preferred embodiment, the fiber-containing substrate, for example, HEXCEL 1280 available from Hexcel, or some other woven substrate, is utilized. Style 1280 fiber glass fabric is characterized as a plain weave E-glass with a 5 micron fiber diameter, having a construction of 23.6×23.6 yarns per cm, a weight of 56 g/m², a thickness of 0.06 mm.

The aqueous polymer dispersions of the present disclosure can be used to coat substrates such as the fiber-containing substrates previously described.

Before coating, the aqueous polymer dispersion may be mixed with further ingredients such as binders, pigments, and/or other adjuvants, to prepare a coating composition as may be desired for the particular coating application. For example, the ETFE copolymer dispersion may be combined with polyamide imide and polyphenylene sulfone resins as disclosed in for example WO 94/14904 (Fernand) to provide anti-stick coatings on a substrate. Further coating ingredients include inorganic fillers such as colloidal silica, aluminum oxide, and inorganic pigments as disclosed in for example U.S. Pat. No. 3,489,595 (Brown) and 4353950 (Eustathios).

In one embodiment, the fiber-containing substrate is heated before the application of the aqueous polymer dispersion of the present disclosure. Such heating processes are known in the art and can occur at temperatures above 500, 600, 700, 800 or even 900° C., but below the decomposition of the fiber to (a) clean, for example, remove sizings or surface lubricants and/or (b) to improve the properties of the fiber-containing substrate (such as anneal stress from the fibers, increase stiffness, increase modulus, etc.).

The aqueous polymer dispersion of the present disclosure may be applied to a substrate by using common techniques such as spraying, roller, dip, or curtain coating using for example a dip coater, multiple dip coater, kiss coater, floating knife coater: drying the substrate to remove volatile components; and baking the substrate. When baking temperatures are high enough, the primary dispersion particles fuse (or anneal) and become a coherent mass.

The performance of the coated finished product depends to a certain extent on the ability of the ETFE coating to penetrate and coat the fiber-containing substrate.

The substrate may or may not be cleaned prior to coating the aqueous polymer dispersion. In one embodiment, the substrate is substantially free of a base (or primer) layer between the substrate and the ETFE layer. In one embodiment, the substrate comprises a sizing (such as a starch). In one embodiment, the substrate is caramelized, wherein the sizing is burned off prior to coating of the aqueous polymer dispersion.

In one embodiment, the substrate (fiber-containing substrate or fabric as described above) is dipped into a vat or other suitable container filled with the aqueous polymer dispersion disclosed herein and is allowed to soak up the fluoropolymer. The impregnated substrate is then urged between oppositely disposed doctoring blades or drag knives which smooth the ETFE copolymer coating and maintain the thickness of coating to a desired thickness.

The substrate can be repeatedly coated (optionally dried and/or annealed between coats) to achieve a substrate sufficiently coated with ETFE. In other words, when visually inspected, the coated substrate shows no visible pinholes.

In one embodiment, the aqueous polymer dispersions have improved shear stability as compared to aqueous polymer dispersions not comprising the non-ionic, branched, alkoxy alcohol surfactant disclosed herein. The improved shear stability is advantageous especially for high speed coating or pumping the dispersion.

In one embodiment, the aqueous fluoropolymer dispersions of the present disclosure have a reduced surface tension as compared to the same aqueous fluoropolymer dispersion using a different non-ionic surfactant. Such a property may assist in wetting of the substrate.

After coating, the coated substrate is then heated in an oven to effect curing. The oven temperature can be varied, depending on how long the coated substrate takes to make its way through the oven (residence time). The temperature of the oven and the time exposed to said temperature need to be adequate to allow the volatiles from the dispersion to evaporate and the ETFE polymer particles to anneal to form the coating. Lower temperatures may first be employed to dry the coating, wherein the solvent, water and/or other compounds such as surfactants are evaporated. A higher temperature may then be used to anneal the polymer particles and form the coating. Typically, the higher temperature is above the melting point of the ETFE. For example, at temperatures above 200 or even 225° C.

In one embodiment, the coated fiber-containing substrate comprises at least 50, 60, or even 65 g of ETFE copolymer per square meter; and at most 100, 90, 80, or even 75 g of ETFE copolymer per square meter.

In one embodiment, the coated fiber-containing substrate c of the present disclosure is stiffer than the same fabric coated with a perfluorinated polymer.

The coated articles can be used in a variety of applications including: architectural applications, electrochemical device applications, non-stick sheet applications and conveyer belts

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods. Unless otherwise noted, surfactant concentrations, reported in either parts per million (ppm) or weight percent (wt %) are calculated relative to fluoropolymer solids content.

These abbreviations are used in the following examples: ppm=parts per million; mg=milligrams, g=grams, sec=seconds, min=minutes, h=hours, ° C.=degrees Celsius, mN=milliNewtons, mW=milliWatts, nm=nanometers, μm=micrometers, mm=millimeters, cm=centimeters, m=meters, mL=milliLiters, G=g-force, N/kg=Newtons per kilogram, kcps=thousand counts per second, rpm=revolutions per minute, w %=weight percent, tex=mass in grams per 1000 meters of filament.

### Materials

| | |
|---|---|
| ETFE Dispersion | Aqueous ETFE dispersion comprising (by total |
| | monomer weight) 72.3 wt % tetrafluoroethylene, |
| | 20.1 w % ethylene, 4.1 w % HFP, and 3.5 w % |
| | PPVE-3 |
| PTFE Dispersion | Aqueous PTFE dispersion commercially |
| | available from 3M Company, St. Paul, MN, |
| | USA under the trade designation “3MTM |
| | Dyneon PTFE TF 5060GZ” |
| Anionic Emulsifier | CF₃OCF₂CF₂CF₂OCHFCF₂CO₂NH₄, the |
| | ammonium salt of the compound prepared as in |
| | “Preparation of Compound 11” in U.S. Pat. No. |
| | 7,671,112 (Hintzer et al.) |
| Tergitol TMN-6 | Branched secondary alcohol ethoxylate |
| | nonionic surfactant, available under the trade |
| | designation TERGITOL TMN-6 from The Dow |
| | Chemical Company, Midland, MI, USA |
| Tergitol TMN-10 | Branched secondary alcohol ethoxylate |
| | nonionic surfactant, available under the trade |
| | designation TERGITOL TMN10 from The |
| | Dow Chemical Company |
| Genapol X080 | Fatty alcohol ethoxylate nonionic surfactant |
| | available under the trade designation |
| | GENAPOL X080 from Clariant, Charlotte, NC, |
| | USA |
| Triton X-100 | Octylphenol ethoxylate nonionic surfactant |
| | available under the trade designation TRITON |
| | X-100 from The Dow Chemical Company |
| Fiber Glass Fabric | A glass fiber fabric having a weight of 56 g/m², |
| | and a construction of 23.6 × 23.6 fibers/cm of |
| | continuous filament, 5 μm diameter, E glass, |
| | available under the trade designation 1280 from |
| | Hexcel, Sequin, TX, USA, used as received. |
| 2-butoxyethanol | Available from Sigma-Aldrich |

Method for Determining Dispersion Solid Content

Solid content (fluoropolymer content) of ETFE dispersions was determined gravimetrically according to DIN EN ISO 12086. A correction for non-volatile salts was not made.

Method for Determining Dispersion Surface Tension

Surface tension of the aqueous fluoropolymer dispersion was determined according to DIN EN 14370:2004.

Method for Determining Dispersion Particle Size

ETFE dispersion particle size determination was conducted by dynamic light scattering according to DIN ISO 13321 (1996). A Zeta Sizer Nano ZS, available from Malvern Instruments Ltd, Malvern, Worcestershire, UK, equipped with a 50 mW laser operating at 532 nm was used for the analysis. 12 mm square glass cuvettes with round aperture and cap (PCS 8501, available from Malvern Instruments Ltd) were used to mount a sample volume of 1 mL. Since light scattering of surfactants is extremely sensitive to the presence of larger particles, e.g. dust particles, the presence of contaminants was minimized by thoroughly cleaning the cuvettes before the measurements. The cuvettes were washed with freshly-distilled acetone for 8 h in a cuvette washing device. Dust discipline was also applied to the samples by centrifuging the surfactant solutions in a laboratory centrifuge at 14,500 G (142,196 N/kg) for 10 min prior to the measurements. The measuring device was operated at 25° C. in 173° backscattering mode. Low correlation times of t<1⁻⁶ sec were enabled by the research tool (the research tool is a software up-grade of the standard instrument provided by the supplier). In order to exploit the complete scattering ability of the sample volume, the following settings were applied in all cases: “attenuator,” 11; “measurement position,” 4.65 mm (center of the cell). Under these conditions, the baseline scattering of pure water (reference) is around 250 kcps. Each measurement consisting of 10 sub-runs was repeated for five times. The particle sizes are expressed as D₅₀ value.

Method for Determining Dispersion Stability

To measure the dispersion stability, 130 g of an ETFE dispersion was placed into a 250 mL beaker. The mixer (IKA Ultra-Turrax T5 digital, available from Cole-Parmer, Vernon Hills, Ill., USA) was centered in the beaker at a height of 7 mm above the bottom of the beaker. The temperature of the dispersion was approximately 25° C. The mixer was started at 8000 rpm and, at the same time, 20 g of 2-butoxyethanol was added to the beaker. The time elapsed from the addition of 2-butoxyethanol to the coagulation of the dispersion was recorded as the result.

General Method for Dip Coating Fabric

A glass fiber fabric with a width of 100 cm was passed through a coating tower at a speed of 0.5 m/min. The fabric ran from an unwinder roll into a dip tank containing ETFE dispersion. After passing out of the dip tank, doctor blades controlled the amount of pick-up of ETFE dispersion. The wet, coated fabric then ran through an oven with several temperature zones: first, a drying zone with a temperature of approximately 70° C.; next, a baking zone with a temperature of approximately 200° C.; and last, a curing zone with a temperature of approximately 330° C.

After a first pass through the coating tower, the coating weight was determined in g/m² as the difference between the weight of the coated fabric and the weight of the uncoated fabric. The coated fabric was inspected by optical microscope to determine completeness of the coating. If necessary to close the openings in the fabric construction completely, repeated passes were completed under the same conditions.

### Example 1 (EX-1)

The solid content of the raw ETFE dispersion used in EX-1 was 25.1% and the particle size was approximately 75 nm. This dispersion included a level of approximately 3600 ppm Anionic Emulsifier. This dispersion was contacted with a cation exchange resin to eliminate manganese ions from a permanganate polymerization initiator as described in Example 1 of U.S. Pat. No. 5,463,021. To the resulting dispersion was then added a 1:1 mixture of Tergitol TMN6 and TMN10 with a concentration of surfactant in the dispersion of 8 wt % active content based on the solid polymer. The dispersion was then contacted with an anion exchange resin to reduce the concentration of Anionic Emulsifier. The resulting product showed a level of 40 ppm Anionic Emulsifier. The resulting dispersion was then upconcentrated via ultrafiltration to 44.0% solid content and 6.0% Tergitol mixture. After upconcentration, additional Tergitol mixture was added to reach a final surfactant content of approximately 10.2%, calculated relative to solid content. This dispersion showed a surface tension of 28.8 mN/m and a stability of=12:32 (min:sec)

### Comparative Example 1 (CE-1)

The solid content of the raw ETFE dispersion used in CE-1 was 25.0% and the particle size was approximately 75 nm. This dispersion included a level of approximately 3600 ppm Anionic Emulsifier. This dispersion was contacted with a cation exchange resin to eliminate manganese ions from a permanganate polymerization initiator as described in Example 1 of U.S. Pat. No. 5,463,021. To the dispersion was then added Genapol X080 to a concentration of surfactant in the emulsion of 11%. The dispersion was then contacted with an anion exchange resin to reduce the concentration of Anionic Emulsifier. The resulting product showed a level of 56 ppm Anionic Emulsifier. The resulting dispersion was then upconcentrated via ultrafiltration to 43.7% solid content and 7.5% Genapol X080. After upconcentration, additional Genapol X090 was added to reach a final surfactant content of approximately 10.3%, calculated relative to solid content. This dispersion showed a surface tension of 30.9 mN/m and a stability of=10:47 (min:sec)

### Comparative Example 2 (CE-2)

The solid content of the raw ETFE dispersion used in CE-2 was 25.0% and the particle size was 75 nm. This dispersion included a level of approximately 3600 ppm Anionic Emulsifier. This dispersion was contacted with a cation exchange resin to eliminate manganese ions from a permanganate polymerization initiator as described in Example 1 of U.S. Pat. No. 5,463,021. To the dispersion was then added Triton X-100 to a concentration of surfactant in the emulsion of 11.0%. The dispersion was then contacted with an anion exchange resin to reduce the concentration of Anionic Emulsifier. The resulting product showed a level of 30 ppm Anionic Emulsifier. The resulting dispersion was then upconcentrated via ultrafiltration to 43.3% solid content and 8.3% Triton X-100. After upconcentration, additional Triton X-100 was added to reach a final surfactant content of approximately 11.3%, calculated relative to solid content. This dispersion showed a surface tension of 32.8 mN/m.

### Example 2 (EX-2)

For EX-2, an ETFE dispersion produced as described in EX-1 was used to coat an E glass fiber fabric with a weight of 56 g/m², having a construction of 23.6×23.6 fibers/cm of continuous filament, 5 μm diameter, E glass, available under the trade designation 1280 from Hexcel, Sequin, Tex., USA, following the procedure outlined in the General method for dip coating fabric, above. After four passes through the coating tower, the fabric was observed to be completely sealed. The coated fabric was observed to be noticeably more resistant to bending than the fabric sample coated in CE-3. Total Fabric Weight, the Coating Weight (difference between Total Fabric Weight and uncoated fabric weight), and sealing observations are summarized in Table 2, below.

TABLE 2

| Pass | Total Fabric Weight | Coating Weight | Fabric |
|---|---|---|---|
| Number | (g/m²) | (g/m²) | Sealing |
| 0 | 48 | N/A | Incomplete |
| 1 | 69 | 21 | Incomplete |
| 2 | 85 | 37 | Incomplete |
| 3 | 97 | 49 | Incomplete |
| 4 | 117 | 69 | Complete |

N/A = Not Applicable

### Comparative Example 3 (CE-3)

For CE-3, a glass fiber fabric sample was coated as described for EX-2, except that the fluoropolymer dispersion used was the PTFE Dispersion. After 3 passes through the coating tower, the fabric was observed to be completely sealed. Strips of CE-3 and EX-2 were simultaneously held horizontally by hand and the bend in each sample was observed. EX-2 had a slight bend but was relatively horizontal, while CE-3 showed substantial bend at more than 45 degrees from horizontal.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. An aqueous polymer dispersion comprising:
(a) an ethylene-tetrafluoroethylene copolymer;
(b) 1-25 wt % of a non-ionic, branched, alkoxy alcohol surfactant versus the ethylene-tetrafluoroethylene copolymer, wherein the non-ionic, branched, alkoxy alcohol surfactant comprises at least two —CH(CH₃)₂ groups; and
(c) 0.05-5 wt % non-fluorinated anionic surfactant versus the ethylene-tetrafluoroethylene copolymer.

2. (canceled)

3. The aqueous polymer dispersion of claim 1, wherein the non-ionic, branched, alkoxy alcohol surfactant is 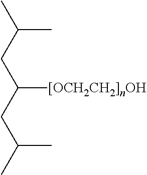
where n is an integer from 6-12.

4. The aqueous polymer dispersion of claim 1, wherein the aqueous polymer dispersion comprises at least 40 wt % ETFE.

5. The aqueous polymer dispersion of claim 1, wherein the non-fluorinated anionic surfactant is selected from alkyl sulfonates, alkyl sulfates, alkylarylsulfonates and alkylarylsulfates, fatty (carboxylic) acids and salts thereof, and phosphoric acid alkyl or alkylaryl esters and salts thereof.

6. The aqueous polymer dispersion of claim 1, wherein the aqueous polymer dispersion is substantially free of a fluorinated emulsifier.

7. The aqueous polymer dispersion of claim 1, wherein the aqueous polymer dispersion comprises a sugar-based emulsifier.

8. The aqueous polymer dispersion of claim 7, wherein the sugar-based emulsifier is a glycoside.

9. The aqueous polymer dispersion of claim 1, wherein the ethylene-tetrafluoroethylene copolymer is derived from (i) 45-90 wt % tetrafluoroethylene; and (ii) 5-40 wt % ethylene.

10. The aqueous polymer dispersion of claim 9 further comprising an additional monomer.

11. The aqueous polymer dispersion of claim 10, wherein the additional monomer is (iii) 0.5-30 wt % hexafluoropropylene; (iv) 0.5-30 wt % vinylidene fluoride; and/or (v) 0.5-10 wt % other comonomers.

12. The aqueous polymer dispersion of claim 11, wherein the other comonomer is trifluorochloroethylene, fluorinated vinyl ether, a fluorinated allyl ether, or combinations thereof.

13. The aqueous polymer dispersion of claim 1, wherein the aqueous polymer dispersion has a surface tension of no more than 30 mN/m.

14. A method of coating a fiber-containing substrate, the method comprising:
coating a fiber-containing substrate with the aqueous polymer dispersion of claim 1, wherein the fiber-containing substrate is made of at least one of glass fiber, aramid fiber, carbon fiber, a high temperature oxide fiber, and a high temperature non-oxide fiber.

15. The method of claim 14, wherein the coated fiber-containing substrate is heated above the melting temperature of the ethylene-tetrafluoroethylene copolymer.

16. A coated fiber-containing substrate made according to the method of claim 14.

17. The coated fiber-containing substrate of claim 16, wherein the coated fiber-containing substrate comprises between 50-100 g of ethylene-tetrafluoroethylene copolymer per meter squared.

18. The coated fiber-containing substrate of claim 16, wherein the coated fiber-containing substrate is substantially free of a base coat.
